(19) United States
(12) Patent Application Publication
(10) Pub. No.: US 2012/0219809 A1
(43) Pub. Date: Aug. 30, 2012

(54) METHOD FOR ENHANCING FRICTION RESISTANCE PROPERTIES

(75) Inventors: Alessandro Benedetto, Paris (FR); Pascal Viel, Meudon (FR); Sophie Noel, Paris (FR)

(73) Assignee: COMMISSARIAT A L'ENERGIE ATOMIQUE ET AUX ENERGIES ALTERNATIVES, Paris (FR)

(21) Appl. No.: 13/395,856

(22) PCT Filed: Sep. 17, 2010
(86) PCT No.: PCT/EP2010/063744

§ 371 Date: Apr. 25, 2012

(30) Foreign Application Priority Data
Sep. 18, 2009 (FR) 09 56450

(51) Int. Cl. B32B 15/08; C08G 61/10; B05D 3/00; B32B 27/00; C25D 7/12; C25D 9/02

(52) U.S. Cl. 428/457; 205/157; 205/317; 427/299; 428/411.1; 428/704; 528/396

(57) ABSTRACT

A method for enhancing the friction resistance properties of a substrate comprising a step consisting of grafting onto all or part of the surface of said substrate a polymer organic film of the non-substituted polyphenylene type as well as to the thus prepared substrate.

### TECHNICAL FIELD

The invention belongs to the field of surface treatments.

More particularly, the present invention aims at providing a method allowing durable treatment of a material in order to modify the lubricating (tribology) and conducting properties thereof and this, notably for modifying the anti-corrosion properties of this material.

The present invention also relates to the thereby treated surfaces.

### STATE OF THE PRIOR ART

Many technological fields set into play complex mechanisms in which movements between mobile parts pose lubrication problems which affect the reliability and the durability of these parts.

These fields are of interest both for computer technology (contact between a hard disc and reading head), and for the space industry (pointing mechanism, deployment of antennas), ultra-vacuum devices (calibration of beams by a diaphragm, displacement mechanism), medical apparatuses (a prosthesis implanted at the joints) and electronic systems such as electric connectors with contact terminals, notably used in the automotive industry and telecommunications, contacts of connectors in current plugs and chips of chip cards.

Indeed, these devices are used under conditions of friction, docking (encounter of two contacts) and fretting (microvibrations to which are constantly subject chip cards in portable telephones), these conditions degrading the technical properties and characteristics of said devices.

Therefore there exists a real need for a method with which the lubricating properties of these devices may be improved. The state of the art is already aware of a number of such methods.

Some of these methods apply an electrically conducting coating notably in gold or a multilayer coating such as a nickel layer on which a fine gold layer has been deposited in order to avoid degradation and corrosion of the devices such as electric connectors. On the one hand, such methods may be burdensome to apply and are especially expensive taking into account the raw material used.

Conventional means such as grease may also be used. However, this technique cannot be used for devices with a micrometric or nanometric size since, at such scales, it is no longer possible to lubricate with conventional means (lubricant, grease) because of stiction phenomena.

The state of the art is also aware of several lubricant fluids. However, the lubrication solutions with lubricating fluids pose the problem of the adhesion of dust or particles of materials which may accumulate in the trace of friction and either lead to an increase in the contact resistance by an electric insulation effect, or to abrasion of the surface and to faster triggering of corrosion.

Mention may also be made of the use of lubricating films which should have certain characteristics. They should have a small thickness, be stable and resistant. Indeed, in all the aforementioned fields, the lubricating film used for reducing friction between moving parts should have a very small thickness so as not to perturb the operating principle of the devices. Thus, in the field of computer technology, the thickness not to be exceeded may be as small as 10 nm. The presence of the lubricant film should not cause pollution of the mechanisms or of the environment, for example due to a too high vapor pressure, to degassing phenomena or liquid flows. Also, the stability of the lubricant should be high in order to ensure that the friction performances are maintained and limit the development of pollution phenomena by formation of degradation by-products, for a duration compatible with the periods during which it is impossible to intervene on the moving parts. The resistance of the lubricant towards an aggressive environment should also be very high.

Thus, the patent EP 0 499 528 proposes the deposition by electropolymerisation at the surface of the devices of a fluorinated polymer film obtained from monomers substituted with fluorinated functional groups or fluorinated aromatic rings. The thereby deposited polymer film has good lubricant properties but should undergo an additional treatment of the irradiation or heat treatment type in order to increase its electric conductivity.

Finally, the international application WO 03/0929614 proposes a bi-layered lubricant coating. The 1^{st} layer of this coating based on partly fluorinated alkenes attached to the device allows the 2^{nd} layer to be maintained, which ensures lubrication by means of the perfluorinated polyether which it contains.

It is therefore clear that in the prior art in order to ensure good lubrication, the lubricant compounds or films include fluorinated groups. Indeed, it is known that fluorinated compounds have interesting properties in terms of lubrication.

However, there exists a need for a method easy to apply, advantageously in one step, capable of improving the lubricating properties, the corrosion resistance of a material and of increasing the durability thereof, but also its conductive properties.

### DISCUSSION OF THE INVENTION

With the present invention it is possible to solve the technical problems and drawbacks listed earlier. Indeed, the present inventors have unexpectedly demonstrated that organic films without any fluorinated, perfluorinated or hydrogenated substitution, grafted on a substrate of interest have lubricating (tribology) and conductive properties without requiring additional treatment. Further, the films applied within the scope of the present invention also provide anti-corrosion properties to the substrates on which they are grafted.

Further, the grafting of such an organic coating allows formation of stable covalent bonds between the surface of the material and said organic coating and is applicable to any type of material. The establishment of covalent bonds between the material and the coating ensures the stability of the pair and participates in the durability of the treatment.

With grafting it is also possible to immobilize the lubricant on the part and to maintain it over time. This is particularly of interest at high temperature notably in the case of satellites thereby avoiding evaporation of the lubricant and under vacuum. By the grafting, there is a control of the lubrication, an exact balance between the improvement in friction resistance (thus in sliding) and the immobilization of the lubricant.

Moreover, grafting may also be used for preventing “picking up” of dust i.e. avoiding that the thereby lubricated part be covered with dust.

The thickness of the organic coating obtained by this grafting is also easily controllable. Thus, the coating may appear in the form of very thin films which do not modify the properties of the coated material.

The surface to be treated may be an insulating, conducting or semiconducting material, notably when the applied grafting method is a chemical or radical grafting. Also, said grafting may be carried out in an aqueous medium and in an organic medium. For these reasons, the method according to the invention is applicable to any type of surface.

Thus, the present invention relates to a method for (enhancing) the friction resistance properties of a substrate comprising a step consisting of grafting on all or part of the surface of said substrate a polymer organic film of the non-substituted polyphenylene type.

By “enhancement in the friction resistance properties” is meant that the substrate subsequently to the method of the invention i.e. the substrate for which at least one area of the surface is coated with a polymer organic film of the non-substituted polyphenylene type has improved properties as compared with the non-coated substrate. This improvement may be demonstrated or quantified by techniques well known to one skilled in the art such as the measurement of the friction coefficient.

By “a polymer organic film of the non-substituted polyphenylene type” or “a non-substituted polyphenylene polymer organic film” is meant within the scope of the present invention a polymer having recurrent units, either identical or different, having one (or more) non-substituted phenyl ring(s). These recurrent units are advantageously selected from the group consisting of the phenyl unit, the naphthalene unit and the anthracene unit, said units not having any substitution. This polymer may be a linear polymer or a polymer having random branches.

Advantageously, the units of the polymer organic film applied within the scope of the present invention stem from one (or more) adhesion primer(s).

By “adhesion primer” is meant within the scope of the present invention any organic molecule which may under non-electrochemical or electrochemical conditions, form either radicals or ions and in particular cations and thereby participate in chemical reactions. Such chemical reactions may notably be chemisorptions and in particular chemical grafting or electro-grafting. Thus, such an adhesion primer is capable, under non-electrochemical or electrochemical conditions, of being chemisorbed on the surface, notably by a radical reaction, and of having another reactive function towards another radical after this chemisorption.

The adhesion primer(s) applied within the scope of the present invention is(are) advantageously selected from the group consisting of an aryl diazonium salt, an aryl ammonium salt, an aryl phosphonium salt, an aryl iodonium salt and an aryl sulfonium salt, said aryl group being a carbonaceous compound having one (or more) non-substituted phenyl ring(s).

Among the cleavable aryl salts which may be used as adhesion primers within the scope of present invention, mention may in particular be made of compounds of the following formula (I):

R—N₂⁺, A⁻ (I)
wherein:
A represents a monovalent anion and
R represents a carbonaceous compound having one (or more) non-substituted phenyl ring(s).

Within the compounds of the formula (I) above, A may notably be selected from inorganic anions such as halides like I⁻, Br⁻ and Cl⁻, halogenoborates such as tetrafluoroborates, perchlorates and sulfonates and organic anions such as alcoholates and carboxylates.

Among the cleavable aryl salts which may be used as adhesion primers within the scope of present invention and notably those of formula (I), mention may be made of primers for which the aryl or R group is an element selected from the group consisting of a non-substituted phenyl, naphthalene and anthracene group.

The benzenediazonium tetrafluoroborate (designated as BD or AND hereafter) is a more particular example of adhesion primers which may be used within the scope of the present invention:

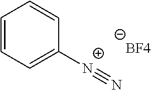

Also, anthracene diazonium tetrafluoroborate and naphthalene diazonium tetrafluoroborate are other examples of primers which may be used within the scope of the invention:

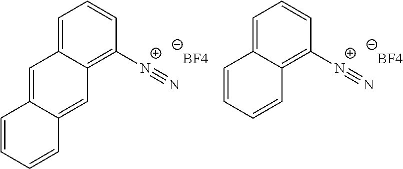

Thus, the organic film applied within the scope of the present invention is essentially a polymer or copolymer, derived from several adhesion primer molecules. The units of the organic film are therefore derived from polymerization notably radical polymerization of the present primers.

Indeed, it should be noted that the adhesion primer molecules may be described as polymerizable insofar that by radical reaction they may lead to the formation of molecules with a relatively high molecular mass, the structure of which is essentially formed with units with multiple derived repetitions, de facto or from a conceptual point of view, of adhesion primer molecules. In such a case, the organic film applied within the scope of the present invention may exclusively consist of units derived or stemming from identical or different adhesion primers.

In a first alternative of the present invention, the applied grafting in the method is chemical grafting.

The term of “chemical grafting” notably refers to the use of extremely reactive molecular entities (typically radical entities) capable of forming bonds of the covalent bond type with a surface of interest, said molecular entities being generated independently of the surface on which they are intended to be grafted. Thus, the grafting reaction leads to the formation of covalent bonds between the area of the surface to be coated with an organic film and the derivative of the adhesion primer.

By “derivative of the adhesion primer” is meant, within the scope of the present invention, a chemical unit resulting from the adhesion primer, after the latter has reacted with the surface, by chemical grafting, and possibly with another chemical compound, by a radical reaction, said other chemical compound giving the second unit of the organic film. Thus, the first unit of the organic film is a derivative of the adhesion primer which has reacted with the surface and with another chemical compound such as another adhesion primer.

Advantageously, this first alternative comprises the steps consisting of:

a₁) putting said surface into contact with a solution S₁ comprising at least one adhesion primer as described earlier;

b₁) subjecting said solution S₁ to non-electrochemical conditions allowing formation of radical entities from said adhesion primer.

Any inorganic or organic, either electrically conducting or not, surface having one or more atom(s) or group(s) of atoms which may be involved in an addition or radical substitution reaction, such as CH, carbonyls (ketone, ester, acid, aldehyde), —OH, ethers, amines, halogens, such as F, Cl, Br, is notably concerned by the present invention.

The surfaces of inorganic nature may notably be selected from conducting materials such as metals, noble metals, oxidized metals, transition metals, metal alloys and for example Ni, Zn, Au, Pt, Ti or steel. These may also be semiconducting materials such as Si, SiC, AsGa, Ga, etc. It is also possible to apply the method to non-conducting surfaces such as non-conducting oxides such as SiO₂, Al₂O₃ and MgO. More generally, an inorganic surface may for example consist of an amorphous material, such as a glass generally containing silicates or further a ceramic, as well as a crystalline material such as diamond, graphite which may be more or less organized, such as graphene, highly orientated graphite (HOPG), or carbon nanotubes.

As a surface of organic nature, mention may notably be made of natural polymers such as latex or rubber, or artificial polymers such as derivatives of polyamide or polyethylene, and notably polymers having bonds of the π type such as polymers bearing ethylenic bonds, carbonyl, imine groups. It is also possible to apply the method to more complex organic surfaces such as leather, surfaces comprising polysaccharides, such as cellulose for wood or paper, artificial or natural fibers, such as cotton or felt, as well as fluorinated polymers such as polytetrafluoroethylene (PTFE) or further to polymers bearing basic groups such as tertiary or secondary amines and for example pyridines, such as poly-4- and poly-2-vinylpyridines (P4VP and P2VP) or more generally polymers bearing aromatic groups and nitrated groups.

The solution S₁ may further comprise a solvent. The latter may be a protic solvent or an aprotic solvent. It is preferable that the adhesion primer which is used, be soluble in the solvent of solution S₁.

By “protic solvent”, is meant within the scope of the present invention, a solvent which includes at least one hydrogen atom which may be released as a proton.

The protic solvent is advantageously selected from the group consisting of water, deionized water, distilled water, either acidified or not, acetic acid, hydroxylated solvents such as methanol and ethanol, liquid glycols with low molecular weight such as ethylene-glycol, and mixtures thereof. In a first alternative, the protic solvent used within the scope of the present invention is only formed by a protic solvent or by a mixture of different protic solvents. In another alternative, the protic solvent or the mixture of protic solvents may be used as a mixture with at least one aprotic solvent, it being understood that the resulting mixture has the characteristics of a protic solvent.

By “aprotic solvent”, is meant within the scope of the present invention, a solvent which is not considered as protic. Such solvents are not able to release a proton or to accept one under non-extreme conditions.

The aprotic solvent is advantageously selected from dimethylformamide (DMF), acetone, tetrahydrofurane (THF), dichloromethane, acetonitrile, dimethyl sulfoxide (DMSO) and mixtures thereof.

The solution S₁ comprising one (or more) adhesion primer(s) as defined earlier, may further contain at least one surfactant and this, notably for improving the solubility of this element. A specific description of the surfactants which may be used within the scope of the invention, is given in patent application FR 2 897 876 to which one skilled in the art may refer. A single surfactant or a mixture of several surfactants may be used.

It is preferable that the adhesion primer be soluble in the solvent of the solution S₁. In the sense of the invention, an adhesion primer is considered as soluble in a given solvent if it remains soluble up to a concentration of 0.5 M, i.e. that its solubility is at least equal to 0.5 M under standard conditions of temperature and pressure (STP). The solubility is defined as the analytic composition of a saturated solution depending on the proportion of a given solute in a given solvent; it may notably be expressed as a molarity. A solvent containing a given concentration of a compound will be considered as saturated, when the concentration will be equal to the solubility of the compound in the solvent. Solubility may be finite as well as infinite. In the latter case, the compound is soluble in any proportion in the relevant solvent.

The amount of adhesion primer present in the solution S₁ in accordance with the method according to the invention may vary depending on the intention of the experimenter. This amount is notably related to the desired thickness of organic film as well as to the amount of adhesion primer which it is possible and conceivable to integrate to the film. Thus in order to obtain a grafted film on the whole of the surface in contact with the solution, a minimum amount of adhesion primer must be used which may be estimated by calculations of molecular hindrance. According to a particularly advantageous embodiment of the invention, the concentration of adhesion primer within the liquid solution is comprised between approximately 10⁻⁶ and 5 M, notably between 10⁻⁴ and 1 M, and in particular between 10⁻³ and 10⁻¹ M.

When the solvent is a protic solvent, and advantageously in the case when the adhesion primer is an aryl diazonium salt, the pH of the solution may be less than 7. It is recommended to operate at a pH comprised between 0 and 3 when the preparation of the adhesion primer is carried out in the same medium as the one of the grafting. If necessary, the pH of the solution may be adjusted to the desired value by means of one or more acidifying agents well known to one skilled in the art, for example by means of organic or mineral acids such as hydrochloric acid, sulfuric acid, etc.

The adhesion primer may either be introduced as such into the solution S₁ as defined earlier, or be prepared in situ in the latter. Thus, in a particular embodiment, the method according to the present invention includes a step for preparing the adhesion primer, notably when the latter is an aryl diazonium salt. Such compounds are generally prepared from arylamines, which may include several amine substituants, such as aniline, 1-aminonaphtalene and 2-aminoanthracene. The preparation is accomplished from these arylamines by reaction with NaNO₂ in an acid medium or with NOBF₄ in an organic medium such as acetonitrile. For a detailed discussion of the experimental methods which may be used for such a preparation in situ, one skilled in the art may refer to the article of Belanger et al., 2006 (Chem. Mater., Vol. 18, pages 4755-4763). Preferably, the grafting will then be directly carried out in the preparation solution for the aryl diazonium salt.

By “non-electrochemical conditions” applied in step (b₁) of the metal according to the invention, is meant within the scope of the present invention in the absence of an external electric voltage. Thus, the non-electrochemical conditions applied in step (b₁) of the method according to the invention are conditions which allow formation of radical entities from the adhesion primer, in the absence of the application of any electric voltage to the surface onto which the organic film is grafted. These conditions involve parameters such as for example the temperature, the nature of the solvent, the presence of a particular additive, the stirring, the pressure while the electric current is not involved during formation of radical entities. The non-electrochemical conditions which allow for the formation of radical entities are numerous and this type of reaction is known and studied in detail in the prior art (Rempp & Merrill, Polymer Synthesis, 1991, 65-86, Hüthig & Wepf).

Thus for example it is possible to act on the thermal, kinetic, chemical, photochemical or radiochemical environment of the adhesion primer in order to destabilize it so that it forms a radical entity. Of course it is possible to act simultaneously on several of these parameters.

Within the scope of the present invention, the non-electrochemical conditions allowing formation of radical entities are typically selected from the group consisting of thermal, kinetic, chemical, photochemical, radiochemical conditions and combinations thereof. Advantageously, the non-electrochemical conditions are selected from the group formed by thermal, chemical, photochemical, radiochemical conditions and their mutual combinations and/or with kinetic conditions. The non-electrochemical conditions applied within the scope of the present invention are more particularly chemical conditions.

The thermal environment depends on temperature. It is easy to control with the heating means customarily used by one skilled in the art. The use of a thermostatic environment has a particular interest when it allows accurate control of the reaction conditions.

The kinetic environment essentially corresponds to the stirring of the system and to the frictional forces. This is not here agitation of the molecules per se (elongation of bonds, etc), but the overall movement of the molecules. By applying pressure, it is notably possible to provide energy to the system so that the adhesion primer is destabilized and may form reactive, notably radical species.

Finally, the action of various radiations such as electromagnetic radiations, gamma radiations, UV rays, electron or ion beams may also sufficiently destabilize the adhesion primer so that radicals and/or ions are formed. The wavelength used will be selected according to the primer used.

Within the scope of chemical conditions, one or more chemical initiator(s) are used in the reaction medium. The presence of chemical initiators is often coupled with non-chemical environmental conditions, as discussed above. Typically, a chemical initiator will act on the adhesion primer and generate the formation of radical entities from the latter. It is also possible to use a chemical initiator, the action of which is not essentially related to the environmental conditions and which may act on vast ranges of thermal conditions or further kinetic conditions. The initiator will preferably be adapted to the environment of the reaction, for example to the solvent.

There exist many chemical initiators. A distinction is generally made between three types depending on the environmental conditions used:
thermal initiators, including the most current ones which are peroxides or azoic compounds. Under the action of heat, these compounds are disassociated into free radicals. In this case, the reaction is carried out at a minimum temperature corresponding to the one required for forming radicals from the initiator. This type of chemical initiators is generally used specifically in a certain interval of temperatures, depending on their decomposition kinetics;
photochemical or radiochemical initiators which are excited by the radiation triggered by irradiation (most often by UV, but also by γ radiations or by electron beams) allowing the production of radicals by more or less complex mechanisms. Bu₃SnH and I₂ belong to the photochemical and radiochemical initiators;
the essentially chemical initiators, this type of initiators, acting rapidly and under standard conditions of temperature and pressure on the adhesion primer in order to allow it to form radicals and/or ions. Such initiators generally have an oxidation-reduction potential which is less than the reduction potential of the adhesion primer used under the reaction conditions. Depending on the nature of the primer, this may thus be for example a reducing metal, such as iron, zinc, nickel; a metallocene such as ferrocene; an organic reducing agent such as hypophosphorous acid (H₃PO₂) or ascorbic acid; an organic or inorganic base under proportions sufficient for allowing destabilization of the adhesion primer. Advantageously, the reducing metal used as a chemical initiator appears in a finely divided form, such as metal wool (also more commonly called “straw”) or metal filings. Generally, when an organic or inorganic base is used as a chemical initiator, a pH greater than or equal to 4 is generally sufficient. Structures of the radical reservoir type, such as polymer matrices irradiated beforehand with an electron beam or with a heavy ion beam and/or with the whole of the irradiation means mentioned earlier, may also be used as chemical initiators for destabilizing the adhesion primer and notably leading to the formation of radical entities from the latter.

It is useful to refer to the article of Mevellec et al, 2007 (Chem. Mater., Vol. 19, pages 6323-6330) for the formation of active species.

In a second alternative of the present invention, the grafting applied in the method is electro-grafting.

By “electro-grafting”, is meant within the scope of the present invention, an electro-initiated and localized grafting method for an adhesion primer which may be electrically activated, on a composite surface comprising electrically conducting and/or semiconducting portions, by putting said adhesion primers in contact with said composite surface. In this method, the grafting is achieved electrochemically in a single step on defined, selected areas of said conducting and/or semiconducting portions. Said areas are brought to a potential greater than or equal to a threshold electric potential determined relatively to a reference electrode, said electric potential threshold being the potential beyond which grafting of said adhesion primers occurs. Once said adhesion primers are grafted, the latter have another reactive function towards another radical and capable of triggering radical polymerization which does not depend on any electric potential.

Advantageously, this second alternative comprises the steps consisting of:

a₂) putting said conducting or semiconducting surface in contact with a solution S₂ comprising at least one adhesion primer as defined earlier;

b₂) polarizing said surface to a more cathodic electric potential than the reduction potential of the adhesion primer applied in step (a₂).

Within the scope of the present invention, by “semiconducting”, is meant an organic or inorganic material having an intermediate electric conductivity between that of metals and insulators. The conductivity properties of a semiconductor are mainly influenced by the charge carriers (electrons or holes) which the semiconductor has. These properties are determined by two particular energy bands called the valence band (corresponding to the electrons involved in covalent bonds) and the conduction band (corresponding to the electrons in an excited state and capable of moving in the semiconductor). The “gap” represents the energy difference between the valence band and the conduction band. A semiconductor also corresponds unlike insulators or metals, to a material, the electric conductivity of which may be controlled, to a large extent, by adding doping agents which correspond to foreign elements inserted into the semiconductor.

The surface applied within the scope of the method according to the invention may be any surface customarily used in electro-grafting and advantageously an inorganic surface. Such an inorganic surface may notably be selected from conducting materials such as metals, noble metals, oxidized metals, transition metals, metal alloys and for example Ni, Zn, Au, Ag, Cu, Pt, Ti and steel. The inorganic surface may also be selected from semiconducting materials such Si, SiC, AsGa, Ga, etc. . . . .

Thus, said inorganic surface applied in the method according to the invention generally consists of a material selected from metals, noble metals, oxidized metal, transition metals, metal alloys and semiconducting materials, either photosensitive or not.

In the scope of the present invention, by “photosensitive semiconductor” is meant a semiconducting material for which the conductivity may be modulated by changes in magnetic field, in temperature or in illumination, which has an influence on the electron-hole pairs and on the density of the charge carriers. These properties are due to the existence of the gap as defined earlier. This gap does not generally exceed 3.5 eV for semiconductors, versus 5 eV in materials considered as insulators. It is therefore possible to populate the conduction band by excitation of the carriers through the gap, notably under illumination. The elements of Group IV of the periodic table, such as carbon (as diamond), silicon, germanium have such properties. Semiconducting materials may be formed with several elements, both from Group IV such as SiGe or SiC, and from Groups III and V, such as GaAs, InP or GaN, or further from Groups II and VI, such as CdTe or ZnSe.

Advantageously, within the scope of the present invention, the photosensitive semiconducting substrate is of inorganic nature. Thus, the photosensitive semiconductor applied within the scope of the present invention is selected from the group consisting of the elements from Group IV (more particularly silicon and germanium); alloys of elements from Group IV (more particularly, SiGe and SiC alloys); alloys of elements from Group III and from Group V (called “III-V” compounds, such as AsGa, InP, GaN) and alloys of elements from Group II and from group VI (called “II-VI” compounds such as CdSe, CdTe, Cu₂S, ZnS or ZnSe). The preferred photosensitive semiconductor is silicon.

In an alternative of the present invention, it is possible that the photosensitive semiconductor be doped with one (or more) dopant(s). The dopant is selected depending on the semiconductor, and the doping is of type P or N. The selection of the dopant and of the doping technologies are routine techniques for one skilled in the art. More particularly, the dopant is selected from the group consisting of boron, nitrogen, phosphorus, nickel, sulfur, antimony, arsenic and mixtures thereof. As examples, for a silicon substrate, among the most used dopants of type P, mention may notably be made of boron and for the dopants of type N, arsenic, phosphorus and antimony.

If the surface applied within the scope of the present invention is in a photosensitive semiconducting material, the method further comprises a step (c₂) consisting of exposing said surface to light radiation, the energy of which is at least equal to that of the gap of said semiconductor. For more details on this particular embodiment, reference should be made to patent application FR 2 921 516.

All what has been described earlier for the solution S₁, i.e. the solvent, the amounts of adhesion primers and of other elements, the preparation of the adhesion primer in situ, the presence of a supporting electrolyte and optionally of a surfactant, also applies to the solution S₂.

However, it should be noted that the solvent of the solution S₂ is advantageously a protic solvent as defined earlier.

According to the invention, it is preferable that the electric potential used in step (b₂) of the method according to the present invention be close to the reduction potential of the applied adhesion primer which reacts at the surface. Thus, the value of the applied electric potential may be up to 50% higher than the reduction potential of the adhesion primer, more typically it will not be greater than 30%.

This alternative of the present invention may be applied in an electrolysis cell comprising different electrodes: a first working electrode forming the surface intended to receive the film, a counter-electrode, as well as optionally a reference electrode.

The polarization of said surface may be carried out by any technique known to one skilled in the art and notably under conditions of linear or cyclic voltammetry under potentiostatic, potentiodynamic, intensiostatic, galvanostatic, galvanodynamic conditions or by simple or pulsed chronoamperometry. Advantageously, the method according to the present invention is carried out under static or pulsed chronoamperometry. In the static mode, the electrode is polarized for a duration generally of less than 2 h, typically less than 1 h and for example less than 20 mins. In the pulsed mode, the number of pulses will be comprised preferentially between 1 and 1,000 or still more preferentially between 1 and 100, their duration being generally comprised between 100 ms and 5 s, typically 1 s.

The thickness of the organic film is easily controllable and this regardless of the alternative of the method of the present invention which is applied, as explained earlier. For each of the parameters such as the duration of step (b₁) or (b₂) and depending on the reagents which will be used, one skilled in the art will be able to determine by iteration the optimum conditions for obtaining a film with a given thickness, not modifying the operating principle of the thereby coated substrates.

Advantageously, the method according to the present invention includes an additional step, prior to chemical grafting or to electrografting, for cleaning the surface on which the organic film is desirably formed, notably by sanding and/or polishing. An additional treatment with ultrasonic waves with an organic solvent such as ethanol, acetone or dimethylformamide (DMF) is even recommended.

The present invention also relates to a substrate on all or part of the surface of which is grafted a non-substituted polyphenylene polymer organic film which may be prepared by a method according to the invention.

Advantageously, the units of the grafted film on the substrate are as defined earlier.

More particularly, the substrate applied within the scope of the present invention may have micrometric and nanometric size. Advantageously, the substrate is a contact for an electric connector notably selected from the group consisting of gold, silver, tin, nickel, palladium, iron, aluminium, copper and alloys thereof.

The present invention finally relates to the use of a non-substituted polyphenylene polymer organic film as defined earlier as a solid lubricant.

Other features and advantages of the present invention will further become apparent upon reading the examples hereafter given as an illustration and not as a limitation.

### SHORT DESCRIPTION OF THE DRAWINGS

FIG. 1 shows the cyclic voltametry of the reduction of AND on <<evaporated gold>> electrodes (sweeping rate 20 mV/s).

FIG. 2 shows the infrared spectrum of the grafted film following reduction of AND.

FIG. 3 shows the development of the average friction coefficient versus the number of wear cycles for films grafted from FL2921, MB91 and MB83 (FIG. 3A) and the electrical contact resistances measured at the end of the track at the end of each wear cycle (FIG. 3B), the applied normal force being 1 N.

FIG. 4 shows the static electrical contact resistances before the beginning of the friction experiment. The statistics are carried out on five measurements for FL2921, on 8 measurements for MB91, on 5 measurements for MB83 and on 15 measurements for gold, the applied normal force being 1 N.

FIG. 5 shows the development of the average friction coefficient versus the number of wear cycles for films grafted from FL2921, MB91 and for non-coated gold, the applied normal force being 2.5 N.

FIG. 6 shows the “mapping” of the development of the friction coefficient in the wear track corresponding to the curves shown in FIG. 4.

FIG. 7 shows the development of the average friction coefficient versus the number of wear cycles for films grafted from MB91 and from AND, the applied normal force being 2.5 N (FIG. 7A) and the electrical contact resistances being measured at the end of the track at the end of each wear cycle (FIG. 7B), the applied normal force being 1 N.

FIG. 8 shows the “mapping” of the development of the friction coefficient in the wear track corresponding to the curves shown in FIG. 7.

FIG. 9 shows photographs of surfaces exposed to the corrosion test (BELLCORE Outdoor test GR-1270-CORE November 1995) for a surface coated with a film obtained from AND (FIG. 9A), from FL2921 (FIG. 9B) and from MB91 (FIG. 9C) and for a non-coated gold plated surface (FIG. 9D).

FIG. 10 shows photographs of surfaces having been subject to friction (800 cycles, 2.5 N) and then exposed to the same corrosion test with a non-coated gold surface (FIG. 10A) and a surface coated with a polyphenylene (FIG. 10B).

FIG. 11 shows the mass gain measured during the preceding test (initial mass before the test—mass after the corrosion test) for a non-coated gold surface and surfaces coated with grafted MB91, FL2921 and AND films.

FIG. 12 shows a gold surface lubricated by a silicone lubricant and then wiped with absorbent paper (FIG. 12A) on the one hand, and a gold surface coated with a film of a fluorinated diazonium salt (FIG. 12B), both surfaces having been sprinkled with carbon black particles and then blown with the air gun.

### DETAILED DISCUSSION OF PARTICULAR EMBODIMENTS

### I. Preparation of the Substrates Coated with a Polymer Organic Film

I.1—Substrate Coated with a Polymer Organic Film Derived from AND

The polymer films derived from AND were obtained by electrochemical deposition. The electrolyte medium consists of acetonitrile as an organic solvent, of tetraethylammonium perchlorate as a supporting salt at a concentration typically of 0.05 M and of AND typically at a concentration of 0.005 M. The polarization procedure is typically one or more linear potential sweep(s) between the rest potential (typically 0 V) and a potential above the reduction potential of the salt (typically −1 V). This procedure is illustrated in FIG. 1.

Films were also prepared by electrochemical deposition, from aniline, from 1-aminonaphthalene or from 2-aminoanthracene by using the same conditions as those described above, the reaction solution further comprising NOBF₄ in order to obtain the corresponding aryle diazonium salt from these arylamines.

I.2—Substrate Coated with a Polymer Organic Film According to the Invention by Chemical Deposition

Films were prepared, by chemical deposition, from aniline, 1-aminonaphthalene or from 2-aminoanthracene.

The procedure used consists of putting into contact aniline, 1-aminonaphthalene or 2-amino-anthracene at 0.1 M in 0.5 M HCl with 0.1 M NaNO₂ and 2.5 g of powdered iron. This reaction is conducted for 3 h at 40° C.

I.3—Substrate Coated with a Polymer Organic Film Derived from Other Adhesion Primers (as a Comparison).

The other adhesion primers applied for grafting a polymer organic film on a substrate are shown below (scheme 1).

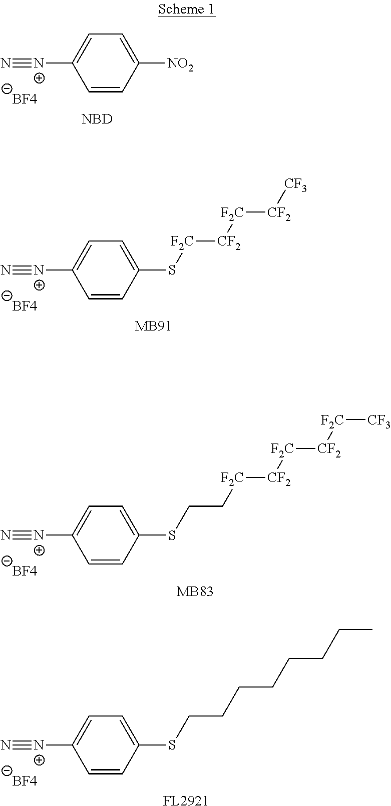

The polymer films derived from diazonium salts shown in scheme 1 are obtained by electrochemical deposition. The electrolyte medium consists of acetonitrile as an organic solvent, of tetraethylammonium perchlorate as a supporting salt at a concentration typically of 0.05 M and of diazonium salts of scheme 1 typically at a concentration of 0.005 M. The polarization procedure is typically one or more linear potential sweeps between the rest potential (typically 0 V) and a potential greater than the reduction potential of the salt (typically −1 V). This procedure is illustrated in FIG. 1.

### II. Characterization of the Thereby Obtained Substrates

The reduction of AND was investigated on “evaporated gold” electrodes. The cyclic voltametry is shown in FIG. 1. On gold electrodes, the molecule behaves like a “conventional” diazonium salt.

A peak is observed matching the reduction of AND at −0.35 V during the 1^{st} cycle. A shoulder is visible at −0.05 V. During the 2^{nd} cycle, the intensity of the peak is considerably reduced and almost no current is observed in the cell after the 3^{rd} cycle. However, under the conditions used, the films derived from AND are insulating films which prevent other electron transfers from the metal electrode through the solution.

The modified electrodes are rinsed and dried. The film is not visible to the naked eye but characteristic bands are observed by ATR-IR (for Attenuated Total Reflection InfraRed). Therefore, the thickness of the film should be less than 10 nm.

IR Characterization

The ATR-IR spectrum of the gold surface modified by electrochemical reduction of AND is shown in FIG. 1.

The spectrum has all the characteristics of a disordered phenylene type film. The band between 3,150-3,020 cm⁻¹ corresponds to the symmetrical and asymmetrical stretching of the —C—H aromatic bond.

The aromatic —C═C— vibrations are visible at 1,600, 1,500 and 1,450 cm⁻¹. In the region of the —C—H aromatic vibrations outside their plane and of the vibrations of the rings out of their plane, four peaks may be observed: two with low intensity at 915 and 845 cm⁻¹ and two strong peaks at 762 and 703 cm⁻¹. In the case of pure disubstitutions 1-4, a single peak should be expected between 860-800 cm⁻¹. This confirms that the reduction of AND produces a structure of the polyphenylene type but disordered and non-linear like a conducting polyphenylene.

The absorptions in the region 900-675 cm⁻¹ indicate the presence of different types of aromatic substitutions such as monosubstitutions, 1-3-, 1-4-disubstitutions, and trisubstitutions. On the basis of IR absorption, a 1,2,3,4-tetrasubstitution may be possible but seems to have to be excluded because of a steric problem. The absence of a linear order in the case of conjugate polymers considerably reduces the length of conjugation of the polymer and delocalization of the charges.

### III. Tribological Tests

III.1—Effect of Fluorination.

The effect of the use as a substituent on the phenyl ring of an aliphatic chain or a fluorinated/perfluorinated chain on the tribological properties was tested by comparing the tribology results between the films grafted with FL2921 and the films grafted with MB83/MB91.

The differences between the molecules are small although significant.

a. Application of a Force of 1 N

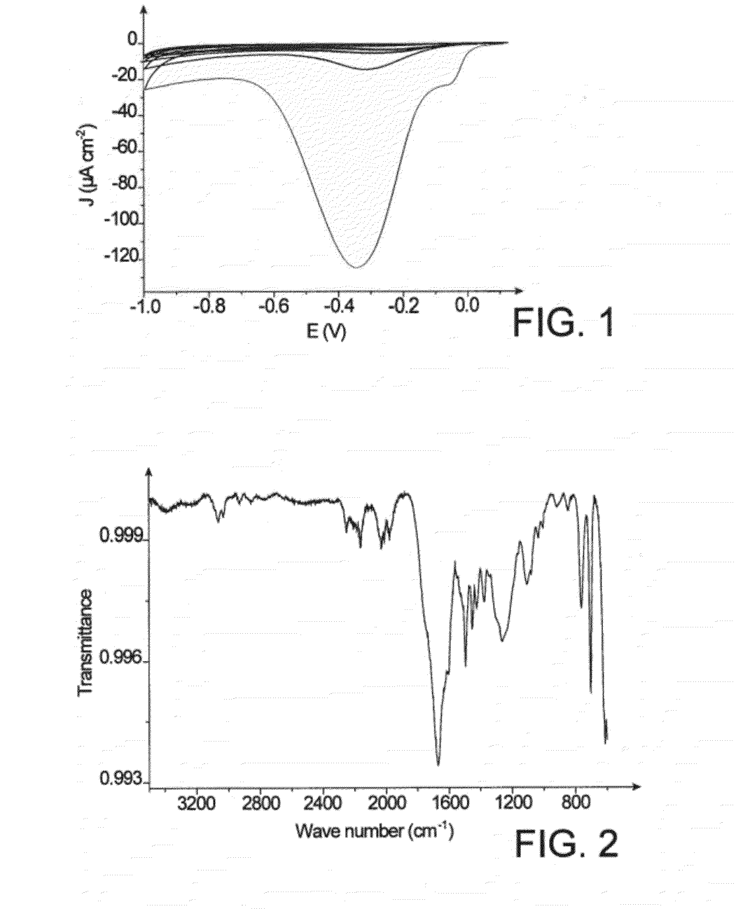

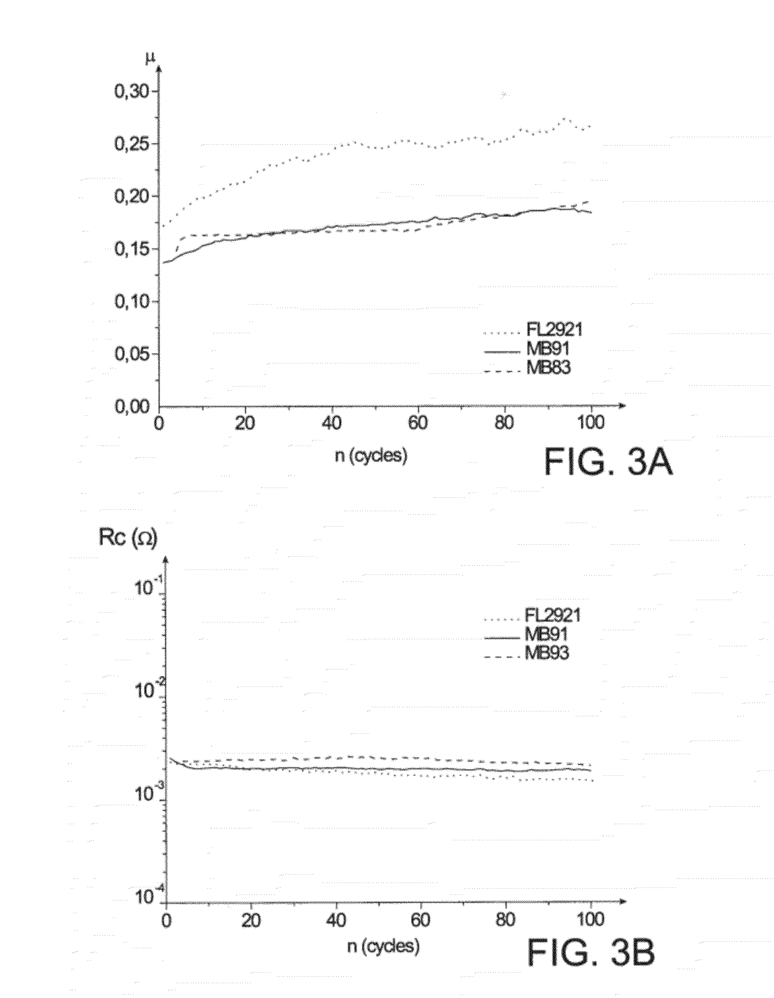

FIG. 3A shows the infrared spectrum of the grafted film following reduction of AND. FIG. 2A shows the development of the average fiction coefficient over 100 cycles with an applied normal force of 1 N for films grafted from three molecules.

The films obtained from MB91 and from MB83 almost show the same behavior. This shows that the effect of the aliphatic spacer is not notable from a tribological point of view. The surface energy of both films was calculated to be 13.2 mN.m⁻¹ for the film grafted from MB91 and 15.7 mN.m⁻¹ for the film grafted from MB83. The difference between the surface energies (2.5 mN.m⁻¹) is however too small for inducing effects on the adhesion term of the friction.

The difference is substantial between aliphatic films grafted from FL2921 and fluorinated films. Over 100 cycles at 1 N, the friction coefficient is around 0.15-0.175 for fluorinated films but starts at 0.175 for hydrogenated films and then increases rapidly up to 0.25.

From the point of view of electric contact resistance, all the films behave in an excellent way. The contact resistance during the experiments is around 2-3 mΩ (FIG. 3B) and remains constant. This means that the films are sufficiently thin for allowing the electric current to circulate through the interface, probably in areas where the film is attached between the irregularities and that no external insulating particle is generated in the wear track. This element together with the fact that the friction coefficient remains low and constant, for all the durations of the experiments shown in FIG. 3, shows that the films are not worn or very little worn during this type of test. This is confirmed by the difficulty of observing under the microscope the wear track produced during experiments at 1 N for 100 wear cycles. In several cases, the only observable phenomenon was the flattening of the lamination strips.

However, during this type of test, the organic films grafted from diazonium act as an excellent protective film for electric contacts.

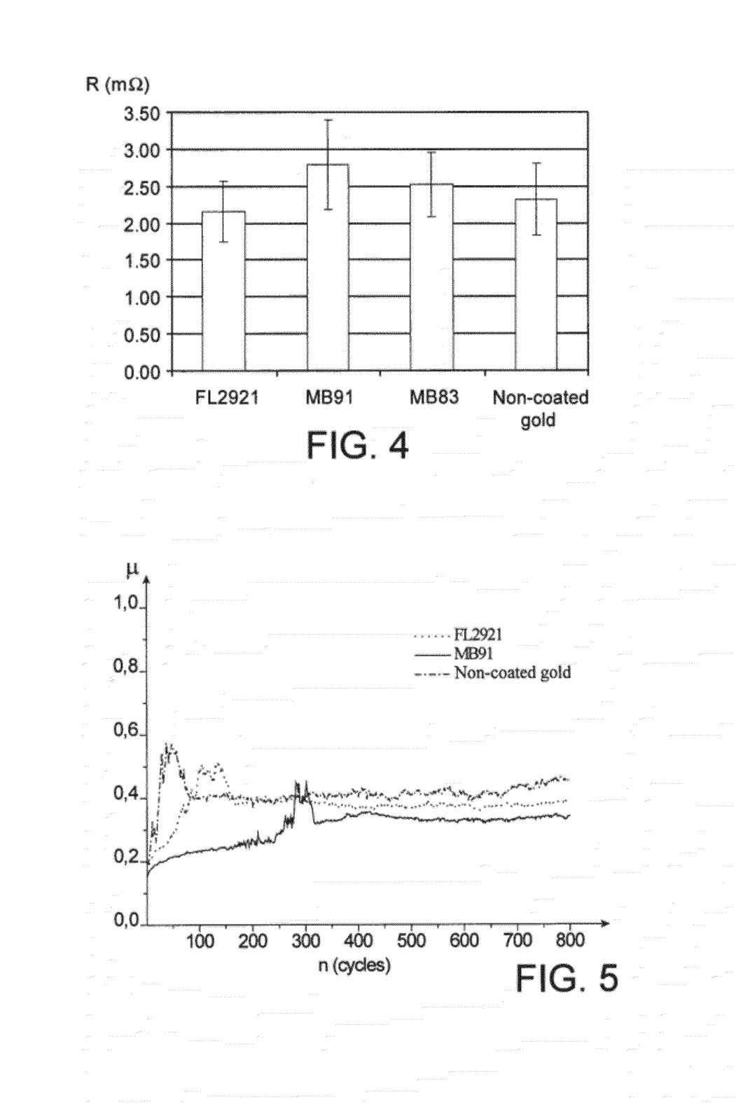

FIG. 4 shows the electrical contact resistance which was measured before the beginning of the experiment for each of the thin films grafted with the diazonium and for the non-coated gold.

The difference in electrical contact resistance between the coated samples and virgin gold is very small and not significant.

The electric resistance is so low that this may mean that the film is sufficiently thin for allowing establishment of direct metal/metal contacts between the irregularities.

However it is surprising that no significant difference is found with the non-coated substrate. This may mean that the same amount of direct contacts is established when the gold is coated and when the gold is non-coated but this explanation may be subject to controversy because of the low measured friction coefficient during the friction and because no adhesion plate is observed in the wear track of the coated substrate after an experiment like the one of FIG. 3.

Another possibility which may explain such a small contact resistance is that electric conduction is effected through the organic film. In fact, the grafting of diazonium salts causes the formation of a structure which is of the poly(phenylene) type. The presence of the substitution groups prevents the accomplishment of coupling of phenyl rings in the films in positions 1-4 as this would be necessary for having the formation of a semiconducting organized linear polyphenylene. Although it is not linear, it consists of coupled phenyl rings which are bound in order to form a polyconjugate backbone. To the knowledge of the inventors, no data exists on the electronic structure of such films in order to know whether there may be electron conductors when they are extremely thin such as in the present examples.

b. Application of a Force of 2.5 N

Although the results obtained at an applied normal force of 1 N are already satisfactory for an industrial application, identical tests were conducted for an applied normal force of 2.5 N so as to see whether it was possible to describe larger differences between films grafted from different diazonium salts.

The development of the friction coefficient is reported in FIG. 4 for a 2.5 N test for 800 cycles on films grafted from FL2921 and from MB91. The results on non-coated gold are shown as a comparison.

The friction coefficient for non-coated gold at 2.5 N is characterized by a rapid increase by about 0.25 to 0.6, the latter value fluctuating between 0.4 and 0.6 depending on the experiments. Subsequently the surfaces of the ball and of the plane plastically deform by increasing the contact surface area (which is expressed in tribology by “the surfaces of the ball and of the plane are mated”), the friction coefficient decreases and attains a plateau around 0.4. This behavior was reproduced for different experiments.

For an applied normal force of 2.5 N, the behavior is more different between hydrogenated and fluorinated films.

The film grafted from MB91 begins with a low friction coefficient (0.15) which increases but remains around 0.2 for at least 200 cycles. Next, a rupture of the film is observed. The friction coefficient increases while having oscillations and attains a plateau, the value of which is comparable with that of non-coated gold.

In the case of hydrogenated films grafted from FL2921, rupture occurs earlier and at about 50 cycles, the film breaks.

The rupture of the film is more easily visible by tracing point by point a “mapping” of the friction coefficient as accomplished in FIG. 5. The friction coefficient is calculated by measuring the instantaneous lateral force on the ball for each position of the wear track. The intensity of the friction coefficient is illustrated by a color scale. Each line along the axis of the abscissae corresponds to the friction coefficient for one cycle. The cycles are then stacked along the axis of the ordinates. This means that the measured friction coefficient for the first cycle is shown at the bottom of the figure, while the measured friction coefficient for the last cycle is illustrated at the top.

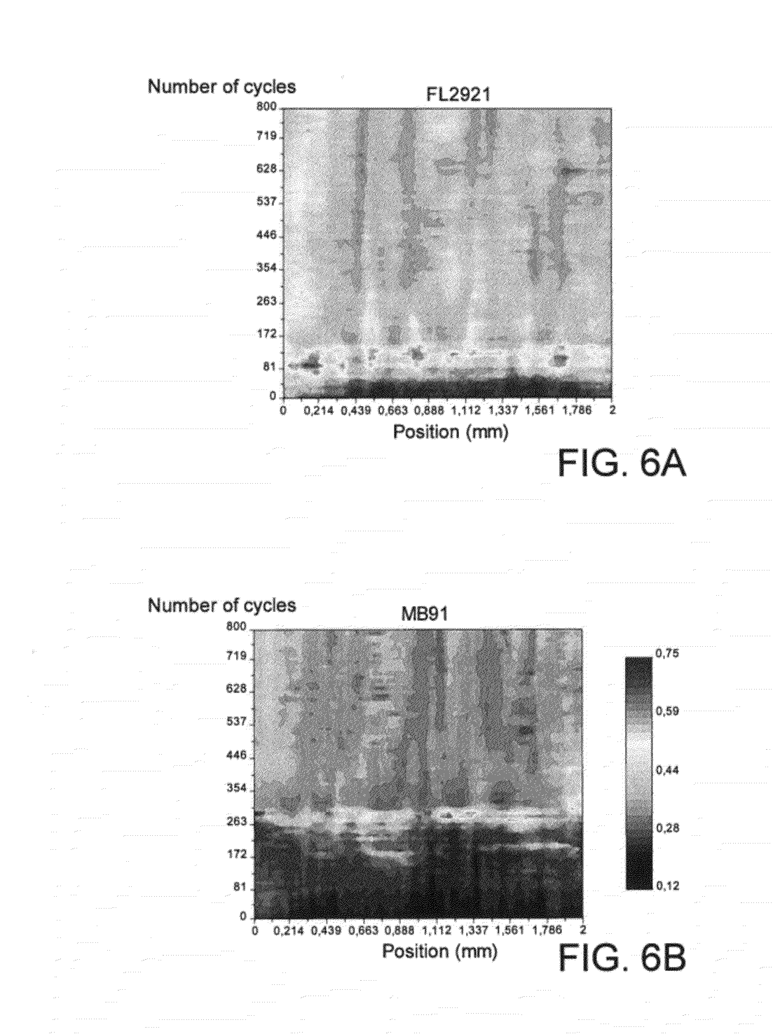

The two mappings corresponding to the films grafted from FL2921 (FIG. 6A) or from MB91 (FIG. 6B) have “vertical lines”. The latter correspond to oscillations in the values of the friction coefficient because of the lamination lines in the substrate which are oriented perpendicularly to the direction of the motion of the ball. Therefore, the irregularities are visible in the form of lines having greater friction values and “depressions” in the form of lines having lower friction values.

The “rupture” is clearly visible on these maps. It occurs as a “catastrophic” event. The damages in the film probably for high friction coefficients do not seem to be localized in a specific point in the wear track but are distributed over the whole of the track. When rupture occurs, it is characterized by a rapid increase in the friction coefficient values which corresponds to the visible peak in the curve of the average development of the friction coefficient of FIG. 5. Next, the friction coefficient decreases somewhat, but however remains at higher values than at the beginning of the experiments.

In the case of FL2921 films, a rupture occurs for lower values of the number of wear cycles than for MB91 films.

This seems probably due to adhesion properties rather then to mechanical properties of the film. The approach-withdrawal curves (D-R) obtained by AFM (Atomic Force Microscopy) reveal that hydrogenated films exhibit better supramolecular organization, are more compact and more difficult to penetrate with a tip than equivalent fluorinated films.

c. Conclusion

The worse performance per tribology test for hydrogenated films as compared with fluorinated films thus occurred on aspects regulated by the adhesion. For hard tests with a large load (2.5 N), the difference in the surface energy level between hydrogenated films and fluorinated films (about 30 mN.m⁻¹) plays an important role. For low loads (1 N), just slight differences are measured in the friction coefficient for two types of films. For high loads, this becomes fundamental for the wear resistance and this may change by far the points at which the rupture of the films occurs.

III.2—Effect of Side Groups.

The approach-withdrawal curves (D-R) obtained by atomic force microscopy or AFM have shown that the internal portion of the diazonium film which corresponds to the portion formed by aromatic rings is the most solid portion and the portion which is the most difficult to penetrate for the AFM tip.

The tribological behavior of substrates functionalized by electrografting of benzene tetrafluoroborate (AND) which is the simplest aromatic diazonium salt without any side group was investigated. For this type of films, the values of the surface energies cannot be as low as for fluorinated salts, but the fact of having mechanically resistant polymers may entail interesting tribological properties.

The results for a severe wear test (applied load 2.5 N) for a surface functionalized with this molecule are reported in FIG. 6 and compared with the results obtained for MB91. The tribological behavior of the surface grafted with a film derived from AND is surprising. The friction coefficient remains low all along the experiment and its profile is extremely regular. The values are around 0.15.

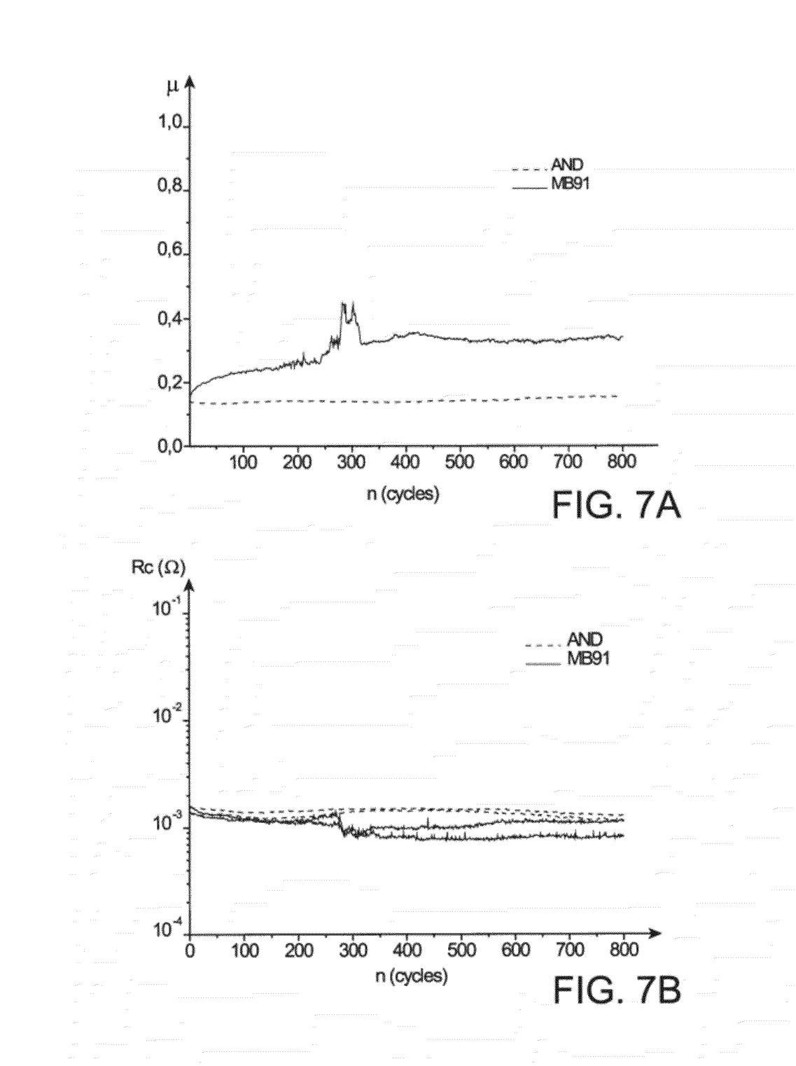

The same regular profile is found for the values of the electrical contact resistance. It is interesting to compare the behavior of the electric contact resistance for both films. Two curves are plotted for each film which represents the values which are measured at each of the ends of the wear track (FIG. 7A and FIG. 7B).

Both values are almost equal for the sample grafted with a film derived from MB91 up to about cycle number 200. Next, the film is degraded and this may be seen at the increase in the friction coefficient values as discussed earlier. The rupture of the film is anyhow also visible from recordings of electric resistances. At the moment of the rupture, the electric contact resistance decreases probably because a higher surface contact is generated. From this point, the values of the resistance at the two ends of the track begin to be different, which means that material is preferentially accumulated at one of the ends and that the organic film when it breaks is therefore pushed towards one of the ends of the rupture track.

On the contrary for a surface grafted with a film derived from AND, the values of the electric contact resistance remain regular and the measured resistances at both ends remain equal. This shows that there is no degradation of the film and that no “catastrophic” event occurs inducing a preferential accumulation of material at one of the two ends of the track.

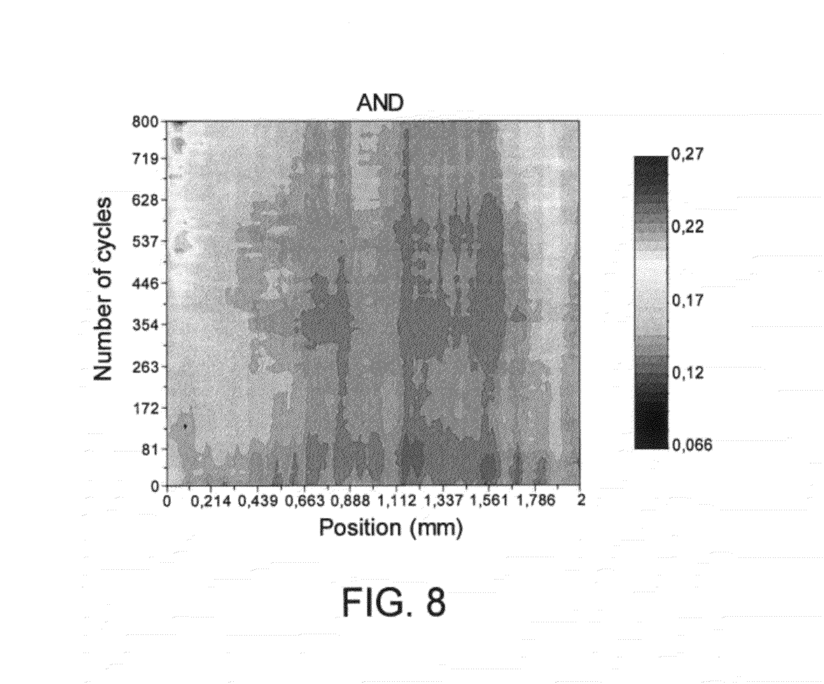

Although no degradation is observed from the development of the average friction coefficient or of the electric contact resistance because they remain constant, additional information may be obtained via the “mapping” of the friction coefficient. The “mapping” corresponding to the experiment of FIG. 7 is shown in FIG. 8. The behavior is radically different from those shown earlier for films grafted from FL2921 or from MB91.

Degradation is visible on the “map” of the friction coefficient. It does not appear as a sudden increase in the friction coefficient at a specific cycle, but appears as being more gradual. In fact, it may be noted that the friction coefficient begins to increase at the ends of the track.

In an alternative tribological test, as the one conducted earlier, the wear is more severe at the ends of the track.

Therefore, the film begins to be damaged at the ends of the track and the values of the friction coefficients increase from around cycle 300. As the increase in the friction coefficient is just localized in the specific points which is almost invisible on the average friction coefficient reported in FIG. 8. The average of all the values recorded on the track is calculated. This “map” obviously shows that the films obtained following reduction of AND resist wear in an exceptional way.

The behavior shown by such films seems even more surprising when they are compared with films obtained by electro-reduction of FL2921, MB91 or MB83.

The presence or the absence of side chains radically changes the modes of wear of the films. Thus, in the case of films having substitutions of the aliphatic or fluorinated chain type, a “catastrophic” rupture is measured. On the contrary, in the case of non-substituted films, the wear method is accomplished slowly, probably with a slow and constant erosion of the organic material.

### IV. Other Results of Corrosion Tests

IV.1—Photos of Coupons of Surfaces Exposed to the Corrosion Test.

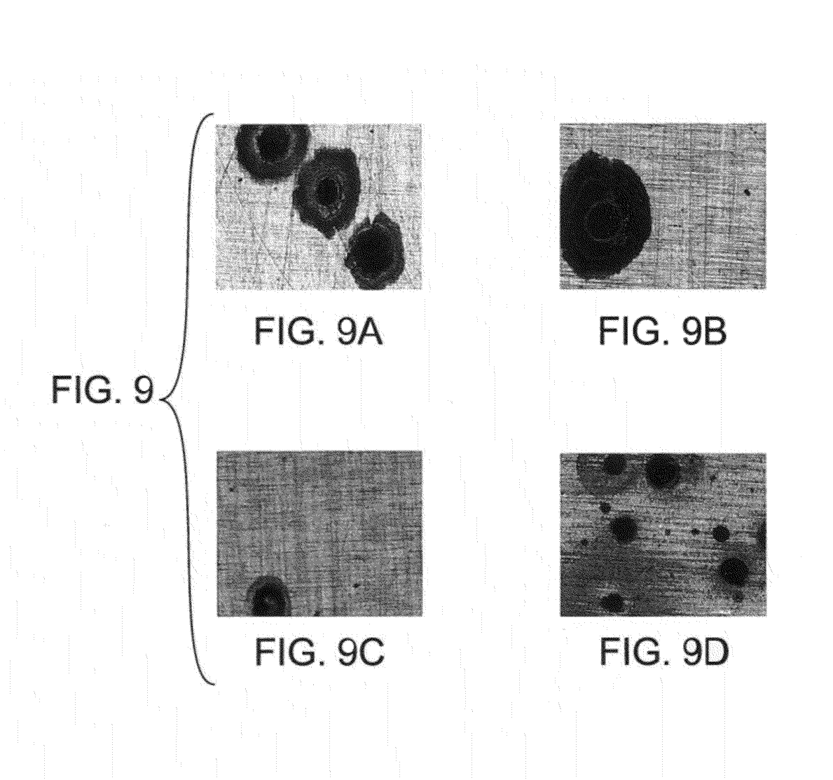

The photographs of FIG. 9 are taken and pinholes are visible. This is why they give a qualitative “image” of the surface and of corrosion pinholes and not a quantitative image.

However it is seen that on the non-coated gold plated surface (FIG. 9D), the pinhole density is higher, as compared with the ones obtained for surfaces coated with a film obtained from AND (FIG. 9A), from FL2921 (FIG. 9B) and from MB91 (FIG. 9C).

IV.2—Photos of Coupons of Surfaces Having been Subject to Friction (800 Cycles, 2.5 N) and then Exposed to the Corrosion Test.

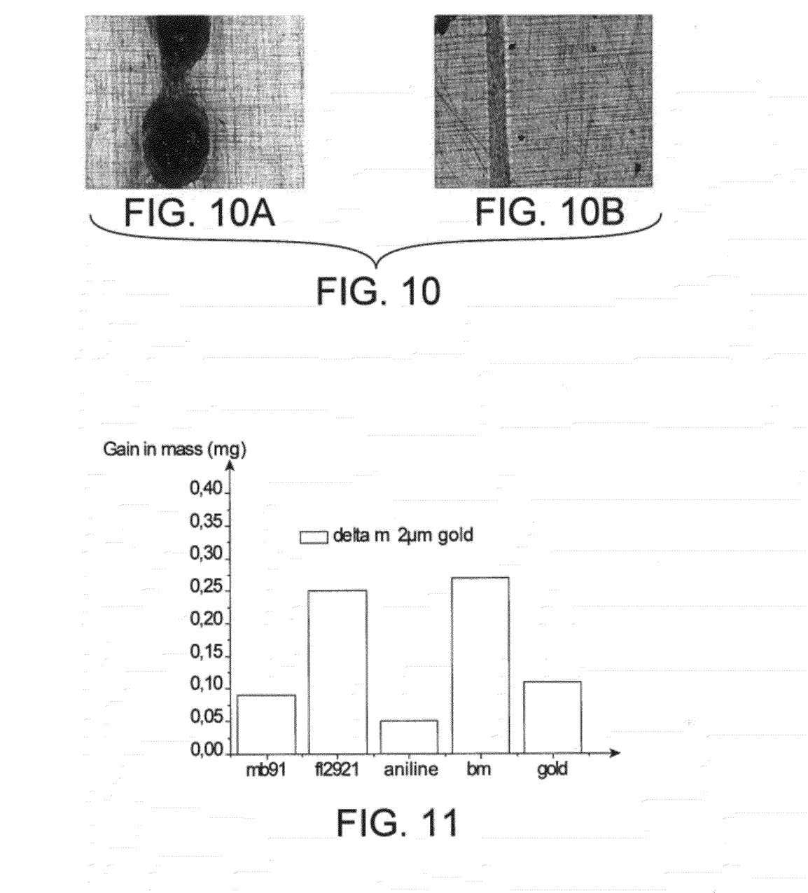

In the absence of coating i.e. non-coated gold (FIG. 10A), the corrosion pinholes are localized on the friction track where nickel is exposed. Galvanic corrosion is then accelerated.

In the presence of a polyphenylene coating (FIG. 10B), the nickel is not exposed and no pinhole is visible. This result may be considered as remarkable on a friction trace of 800 cycles.

IV.3—Mass Gain after a Corrosion Test of the “Batelle” Standard.

The optical observations of the surfaces may be completed by a measurement of the mass gain giving a quantitative idea on the corrosion reactions during the corrosion test. FIG. 11 shows that the maximum protection of the gold plated surface is achieved by the AND layer. With the MB91 layer, the mass gain is less than the case without any protection while with the layer FL2921, the mass gain is greater. The behavior of the AND coating is therefore remarkable.

### V. Anti-Dust Effect of Dry Lubrication

Lubrication solutions with lubricating fluids pose the problem of the adhesion of dust or particles of materials which may accumulate in the friction trace and either lead to an increase in the contact resistance by an electric insulation effect or to abrading the surface and rapidly triggering corrosion.

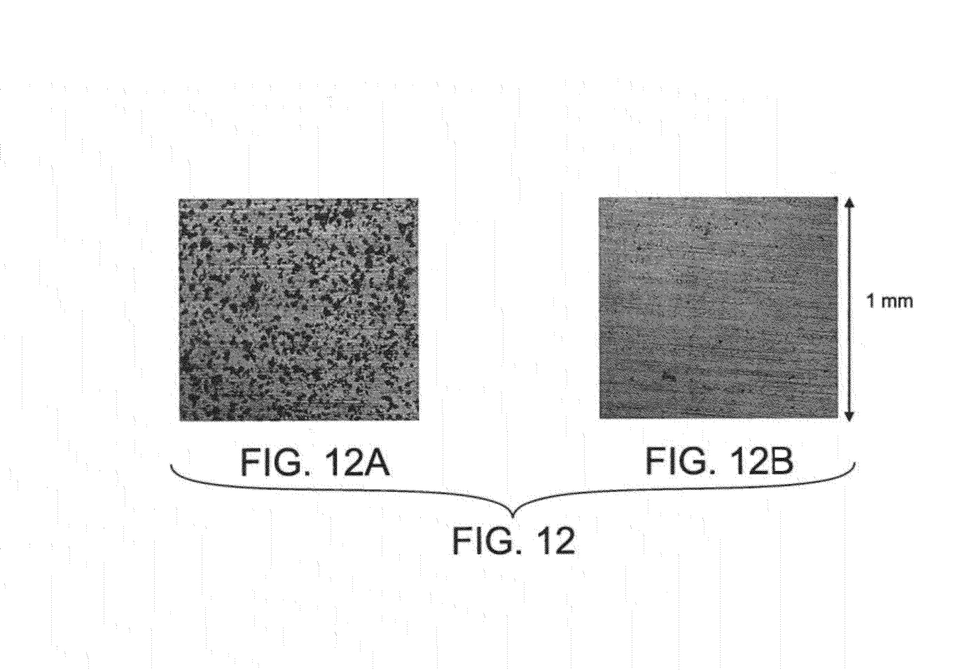

FIG. 12 shows a gold surface lubricated with a silicone lubricant and then wiped with absorbent paper (FIG. 12A) on the one hand and a gold surface coated with a fluorinated diazonium salt film (FIG. 12B) on the other hand, both surfaces having been completely and uniformly sprinkled with carbon black particles and then blown with an air gun. Persistence of the carbon particles in FIG. 12A shows “adhesion” properties of surfaces prepared with liquid lubricants. The absence of any trace of particles in FIG. 12B shows the anti-adhesion properties towards particles of surfaces modified with “dry” films of diazonium salt.

1. A method for improving the friction resistance properties of a substrate comprising a step consisting of grafting on all or part of the surface of said substrate a non-substituted polyphenylene polymer organic film.

2. The method according to claim 1, characterized in that the units of said polymer organic film are derived from one (or more) adhesion primer(s) selected from the group consisting of an aryl diazonium salt, an aryl ammonium salt, an aryl phosphonium salt, an aryl iodonium salt and an aryl sulfonium salt, said aryl group being a carbonaceous compound having one (or more) non-substituted phenyl ring(s).

3. The method according to claim 1, characterized in that the units of said polymer organic film are derived from one (or more) adhesion primer(s) of formula (I):
R—N₂⁺, A⁻ (I)
wherein:
A represents a monovalent anion and
R represents a carbonaceous compound having one more) non-substituted phenyl ring(s).

4. The method according to claim 2, characterized in that
the aryl group or R is an element selected from the group consisting of non-substituted phenyl, naphthalene and anthracene.

5. The method according to claim 1, characterized in that said grafting is chemical grafting.

6. The method according to claim 5, characterized in that said method comprises the steps consisting of:
a₁) putting said surface into contact with a solution S₁ comprising at least one adhesion primer selected from the group consisting of an aryl diazonium salt, an aryl ammonium salt, an aryl phosphonium salt, an aryl iodonium salt and an aryl sulfonium salt, said aryl group being a carbonaceous compound having one (or more) non-substituted phenyl ring(s);
b₁) subjecting said solution S₁ to non-electrochemical conditions allowing the formation of radical entities from said adhesion primer.

7. The method according to claim 1, characterized in that said grafting is electro-grafting.

8. The method according to claim 7, characterized in that said method comprises the steps consisting of;
a₂) putting a conducting or semiconducting surface in contact with a solution S₂ comprising at least one adhesion primer selected from the group consisting of an aryl diazonium salt, an aryl ammonium salt, an aryl phosphonium salt, an aryl iodonium salt and an aryl sulfonium salt, said aryl group being a carbonaceous compound having one (or more) non-substituted phenyl ring(s);
b₂) polarizing said surface to a more cathodic electric potential than the reduction potential of the adhesion primer applied in step (a₂).

9. The method according to claim 1, characterized in that said method includes an additional step, prior to grafting, for cleaning said surface.

10. A substrate on all or part of the surface of which is grafted a non-substituted polyphenylene polymer organic film which may be prepared by a method according to claim 1.

11. The substrate according to claim 10, characterized in that the units of said film are derived from one (or more) adhesion primer(s) selected from the group consisting of an aryl diazonium salt, an aryl ammonium salt, an aryl phosphonium salt, an aryl iodonium salt and an aryl sulfonium salt, said aryl group being a carbonaceous compound having one (or more) non-substituted phenyl ring(s).

12. The substrate according to claim 10, characterized in that said substrate is a contact for an electric connector, notably selected from the group consisting of gold, silver, tin, nickel, palladium, iron, aluminium, copper and alloys thereof.

13. Solid lubricant comprising a non-substituted polyphenylene polymer organic film for grafting onto a surface.

14. The method according to claim 3, characterized in that the aryl group or R is an element selected from the group consisting of non-substituted phenyl, naphthalene and anthracene.
